(19) United States
(12) Patent Application Publication
(10) Pub. No.: US 2006/0179904 A1
(43) Pub. Date: Aug. 17, 2006

(54) Dustproof auxiliary lock

(75) Inventor: Mu-Lin Shen, Tainan (TW)

Correspondence Address: NIKOLAI & MERSEREAU, P.A., 900 SECOND AVENUE SOUTH, SUITE 820, MINNEAPOLIS, MN, 55402, US

(73) Assignee: I-TEK METAL MFG. CO., LTD, Tainan (TW)

(21) Appl. No.: 11/059,765

(22) Filed: Feb. 17, 2005

(51) Int. Cl. E05B 9/08

(52) U.S. Cl. 70/370

(57) ABSTRACT

An auxiliary lock includes a dustproof support ring mounted to an outer side of a door, a cylinder mounted to the outer side of the door, a cylinder housing mounted to the outer side of the door and securely mounted around the cylinder, a trim enclosing the cylinder housing, and a deadbolt mechanism. The dustproof support ring includes a flange on an inner side thereof. The flange extends into a bore hole of the door and is in contact with an inner periphery delimiting the bore hole. A dustproof wall extends from the flange further into the bore hole and is in contact with the inner periphery delimiting the bore hole. The dustproof wall includes a notch through which a retractor of the deadbolt mechanism extends.

### BACKGROUND OF THE INVENTION

1. Field of the Invention

The present invention relates to an auxiliary lock. In particular, the present invention relates to a dustproof auxiliary lock.

2. Description of the Related Art

It is usual to mount an auxiliary lock a door or the like in addition to an entrance lock. A thief can however damage the auxiliary lock by applying an impact to the exposed outside portion of the auxiliary lock with a screwdriver, a hammer, a pair of pliers, or the like. Wood dusts and/or iron dusts are generated while drilling a hole in a door made of wood or steel and mounting the auxiliary lock into the hole of the door. These dusts might fall into the retractor of the latch mechanism of the auxiliary lock, adversely affecting operating smoothness of the retractor and causing malfunction.

U.S. Pat. No. 4,338,804 discloses a latch bolt operating device having improved shield construction to deter probe manipulation. U.S. Pat. No. 5,906,125 to the applicant of the present application discloses an auxiliary lock that reduces the impact damage to the minimum level and that prevents an intruder from damaging the lock by forcedly rotating. However, none of these documents teaches solution to the dusts affecting operation of the retractor.

### SUMMARY OF THE INVENTION

An objective of the present invention is to provide an auxiliary lock that assures smooth operation of the retractor, prolonging the life of the auxiliary lock while improving the structure strength of the auxiliary lock.

An auxiliary lock in accordance with the present invention comprises a dustproof support ring mounted to an outer side of a door, a cylinder mounted to the outer side of the door and including a tail piece, a cylinder housing mounted to the outer side of the door and securely mounted around the cylinder, a trim enclosing the cylinder housing, and a deadbolt mechanism.

The dustproof support ring includes a longitudinal hole. The dustproof support ring further includes a first flange on an inner side thereof. The first flange extends into a bore hole of the door and is in contact with an inner periphery delimiting the bore hole of the door. A dustproof wall extends from the first flange further into the bore hole of the door and is in contact with the inner periphery delimiting the bore hole of the door. The dustproof wall includes a notch.

The deadbolt mechanism includes a retractor extending through the notch of the dustproof wall of the dustproof support ring. The retractor is operably connected to the tailpiece. The deadbolt mechanism further includes a dead bolt operably connected to the retractor.

In a preferred embodiment of the invention, the dustproof wall further includes another notch diametrically opposed to the notch, allowing the auxiliary lock to be mounted to differently handed doors.

Preferably, the cylinder housing further includes a hollow protrusion sandwiched between an outer periphery of the cylinder and an inner periphery delimiting the longitudinal hole of the dustproof support ring.

In an embodiment of the invention, the trim includes a longitudinal hole. A first flange is formed around an outer end of the longitudinal hole. A second flange projects perpendicularly from a peripheral edge of the first flange, defining a space between an inner wall of the trim, the first flange, and the second flange for receiving an outer end portion of the cylinder housing. The trim further includes a third flange extending radially inward from the second flange of the trim and defining a portion of the longitudinal hole of the trim. The cylinder further includes a flange on an outer end thereof, and the flange of the cylinder abuts against the third flange of the trim.

Preferably, the dustproof support ring further includes a second flange on an outer side thereof. The trim includes an inner end fittingly received between the second flange of the dustproof support ring and an outer periphery of the cylinder housing while allowing free rotation of the trim with respect to the cylinder housing and the dustproof support ring.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of a dustproof auxiliary lock in accordance with the present invention.

FIG. 2 is an exploded perspective view of the dustproof auxiliary lock in accordance with the present invention.

FIG. 3 is a sectional view of the dustproof auxiliary lock in accordance with the present invention.

FIG. 4 is a sectional view taken along plane 4-4 in FIG. 3.

FIG. 5 is a perspective view, partly cutaway, of a dustproof support ring of the auxiliary lock in accordance with the present invention.

### DETAILED DESCRIPTION OF THE PREFERRED EMBODIMENT

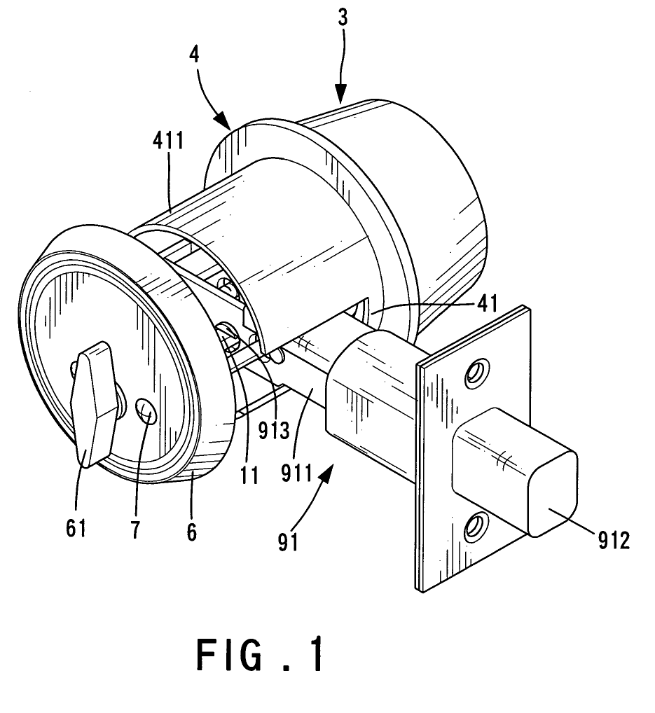

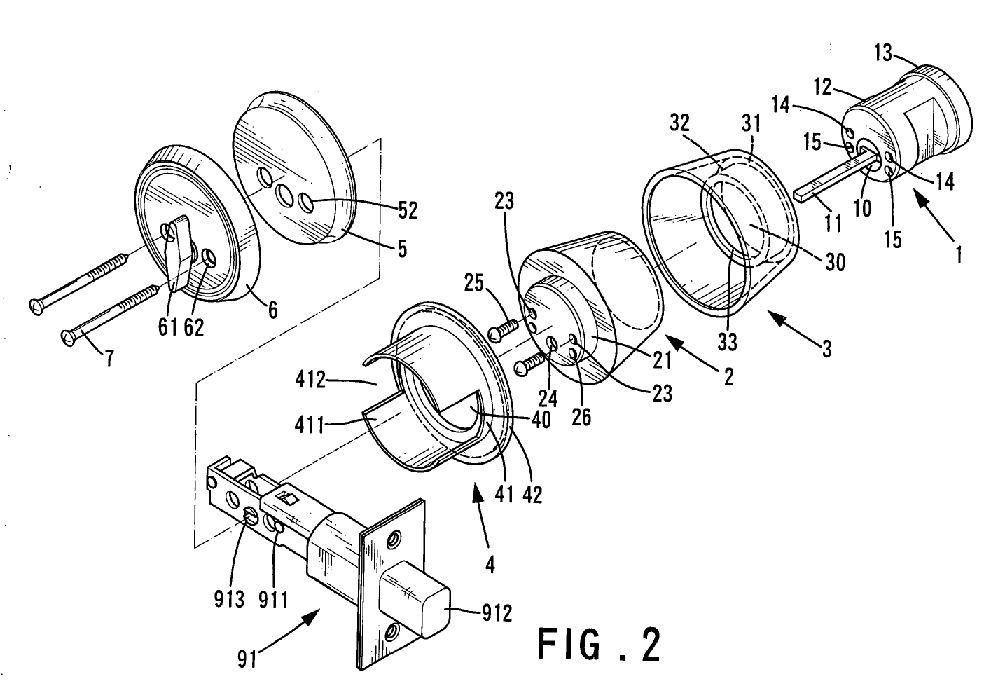

Referring to FIGS. 1 through 4, an embodiment of a dustproof auxiliary lock in accordance with the present invention comprises a cylinder 1 including a lock core 10 with a tailpiece 11 projecting from an end thereof, a cylinder housing 2 securely mounted around the cylinder 1, a trim 3 rotatably enclosing the cylinder housing 2, and a dustproof support ring 4.

In the illustrated embodiment, the dustproof auxiliary lock in accordance with the present invention further comprises a first engaging plate 5, a second engaging plate 6, and a deadbolt mechanism 91 mounted in a door 9. The first engaging plate 5 is firmly engaged with the second engaging plate 6 and then together firmly engaged with the cylinder housing 2. In the illustrated embodiment, two bolts 7 are extended through two hole 62 in the second engaging plate 6, two holes 52 in the first engaging plate 5, two holes 26 in the cylinder housing 2, and two holes 15 in the cylinder 1. A thumb turn or knob 61 is rotatably mounted to the first engaging plate 6 and includes an inner end connected to the tail piece 11 of the cylinder 1. Thus, the tail piece 11 is turned when the knob 61 is turned or a key is inserted into a keyway of the lock core 10 and turned.

The deadbolt mechanism 9 comprises a retractor 911 mounted in a side hole 92 in a side of the door 9. The retractor 911 includes a hole 913 through which the tail piece 11 extends. The deadbolt mechanism 9 further comprises a deadbolt 912 operably connected to the retractor 911 so that the deadbolt 912 is movable between a retracted position in the door 9 and an extended position extending beyond the door 9 into an opening (not shown) in a side of a door frame (not shown) facing the side of the door 9. The retractor 911 is operably connected to the tail piece 11 such that operation of a key for actuating the tail piece 11 or operation of the knob 61 causes movement of the retractor 911, which, in turn, moves the deadbolt 912, which is conventional.

The cylinder 1 further includes two holes 14 in an inner end thereof. The cylinder housing 2 includes a hollow protrusion 21 on an inner end thereof. The hollow protrusion 21 includes two holes 23 aligned with the holes 14 of the cylinder 1. Further, the hollow protrusion 21 includes a hole 24 through which the tail piece 11 extends. Two screws 25 are extended through the holes 23 of the hollow protrusion 21 and the holes 14 of the cylinder 1, thereby securely fixing the cylinder 1 in the cylinder housing 2.

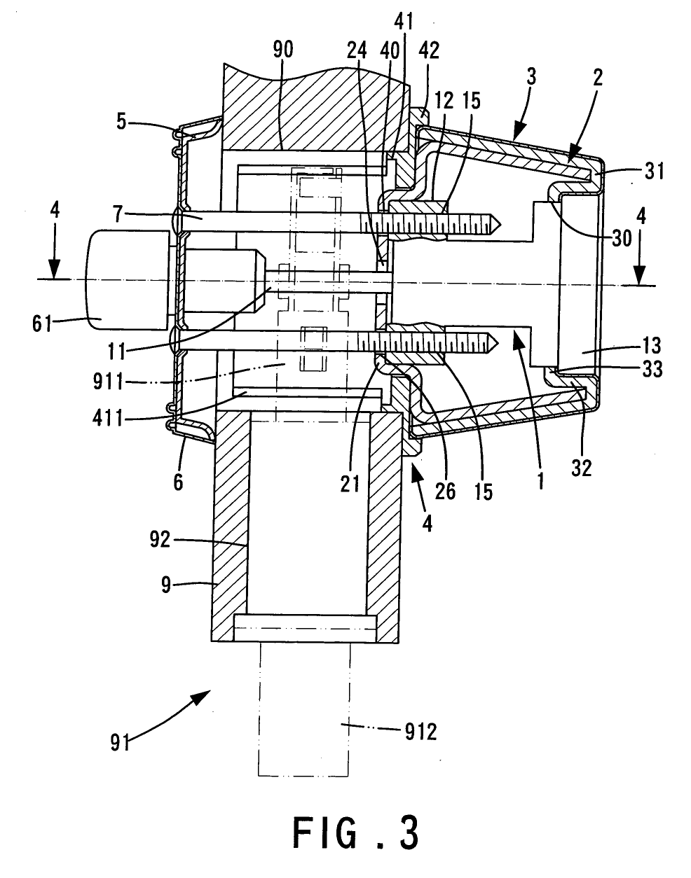

The trim 3 includes a longitudinal hole 30 for rotatably fittingly the cylinder housing 2. A first flange 31 is formed around an outer end of the longitudinal hole 30. A second flange 32 projects perpendicularly from a peripheral edge of the first flange 31, defining a space between an inner wall of the trim 3, the first flange 31, and the second flange 32 for receiving an outer end portion of the cylinder housing 2, best shown in FIG. 3. A third flange 33 extends radially inward from the second flange 32 and defines a portion of the longitudinal hole 30. The cylinder 1 includes a flange 13 that abuts against the third flange 33 when the auxiliary lock is assembled and mounted in the door 9.

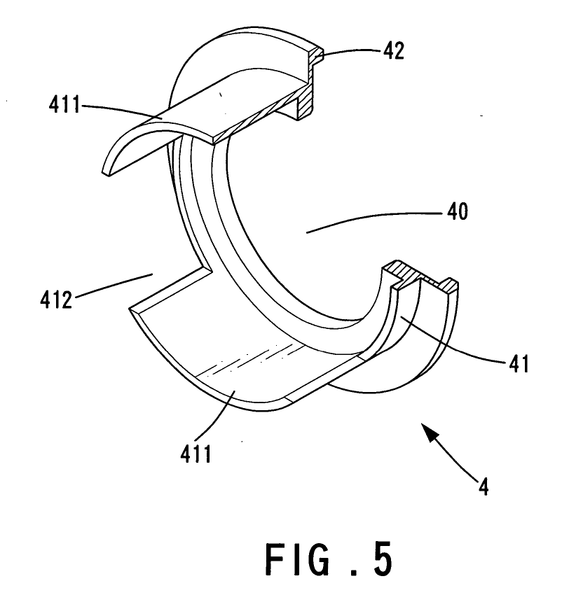

The dustproof support ring 4 includes a longitudinal hole 40. A first flange 41 is formed on an inner side of the dustproof support ring 4 for fittingly holding the hollow protrusion 21. A second flange 42 is formed on an outer side of the dustproof ring 4. As illustrated in FIG. 5, a dustproof wall 411 extends longitudinally from the first flange 41 into a bore hole 90 of the door 9 and in contact with an inner periphery delimiting the bore hole 90 of the door 9. A notch 412 is defined in the dustproof wall 41 to allow mounting of the deadbolt mechanism 91. In the illustrated embodiment, the dustproof wall 41 includes two diametrically disposed notches 412, forming two arcuate walls spaced by two notches 412. Each notch 412 is sized to allow extension of the retractor 911 of the deadbolt mechanism 91. The diametrically disposed notches 412 allow mounting of the auxiliary lock to differently handed doors. Preferably, the length of each notch 412 is slightly smaller than a diameter of the bore hole 90 so that the dustproof wall 41 shields the deadbolt mechanism 91.

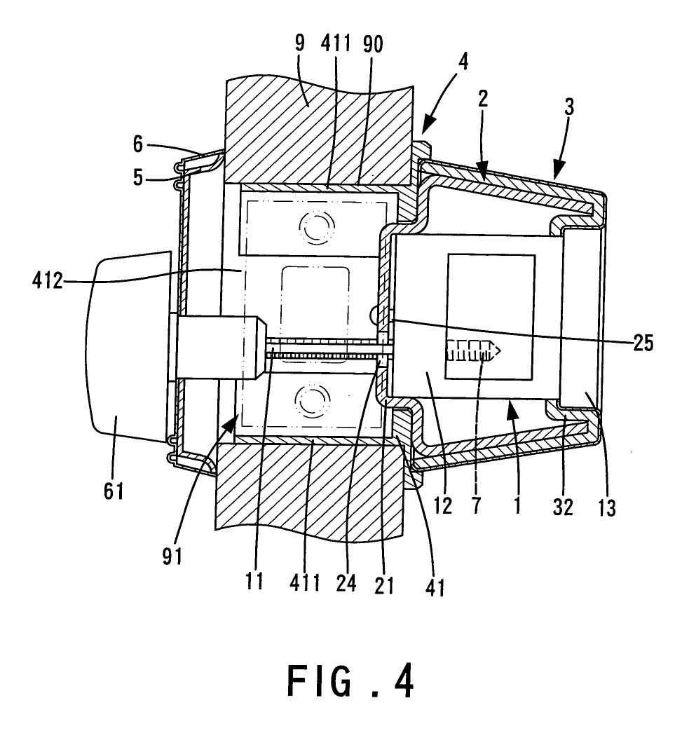

After mounting the auxiliary lock to the door 9, as illustrated in FIGS. 3 and 4, the hollow protrusion 21 of the cylinder housing 2 is fittingly sandwiched between an inner periphery delimiting the longitudinal hole 40 of the dustproof support ring 4 and an outer periphery 12 of the cylinder 1. The first flange 41 of the dustproof support ring 4 extends into the bore hole 90 of the door 9. Preferably, the bore hole 90 is sized to exactly receive the first flange 41 of the dustproof support ring 4. Thus, the cylinder 1 and the cylinder housing 2 mounted to an outer side of the door 9 can be reliably mounted to the door 9 via the dustproof support ring 4. The dustproof support ring 4 evenly release an impact to the door 9 when the trim 3 is experienced with malicious, violent impact from an intruder, thus reducing the impact damage to the auxiliary lock to the minimum level.

The abutment between the third flange 33 of the trim 3 and the flange 13 of the cylinder 1 prevents the trim 3 from being pulled out by an intruder's plies. Further, when the trim 3 is rotated by an external force (e.g., a force from a pair of pliers by an intruder), the trim 3 will rotate with respect to the dustproof support ring 4 and the cylinder housing 2. Thus, the auxiliary lock will not be damaged.

Of more importance, due to provision of the dustproof walls 411 of the dustproof support ring 4 that extend into the bore hole 90 and in contact with an inner periphery delimiting the bore hole 90, the retractor 911 enclosed by the dustproof wall 411 are protected from the wood dusts and/or iron dusts generated during drilling of the bore hole 90 and mounting of the auxiliary lock into the bore hole 90. Another advantage of the dustproof wall 411 of the dustproof support ring 4 is the engaging force between the auxiliary lock and the door 9 is increased, as the dustproof wall 411 extend further into the bore hole 90 and in contact with more area of the inner periphery delimiting the bore hole 90.

It is noted that the first engaging plate 5, the second engaging plate 6, and the knob 61 can be replaced with other structures including, but not limited to, those described and illustrated in U.S. Pat. No. 5,906,125.

Although a specific embodiment has been illustrated and described, numerous modifications and variations are still possible without departing from the essence of the invention. The scope of the invention is limited by the accompanying claims.

1. An auxiliary lock comprising:
a dustproof support ring adapted to be mounted to an outer side of a door, the dustproof support ring including a longitudinal hole, the dustproof support ring further including a first flange on an inner side thereof, the first flange being adapted to extend into a bore hole of the door and be in contact with an inner periphery delimiting the bore hole of the door, a dustproof wall extending from the first flange further into the bore hole of the door and being in contact with the inner periphery delimiting the bore hole of the door, the dustproof wall including an end and a notch axially extending from the end towards but spaced the first flange;
a cylinder adapted to be mounted to the outer side of the door, the cylinder including a tail piece;
a cylinder housing adapted to be mounted to the outer side of the door, the cylinder housing being securely mounted around the cylinder;
a trim enclosing the cylinder housing; and
a deadbolt mechanism including a retractor extending through the notch of the dustproof wall of the dustproof support ring and having a width parallel to the longitudinal hole of the dustproof support ring, the retractor being operably connected to the tailpiece, the deadbolt mechanism further including a dead bolt operably connected to the retractor, with the notch extending from the end a distance greater than the width of the retractor extending through the notch of the dustproof wall, with the dustproof wall having circular cross sections of a constant size from the end to the first flange, with the circular cross sections corresponding to and for slideable receipt in the bore hole of the door.

2. The auxiliary lock as claimed in claim 1, with the dustproof wall further including another notch diametrically opposed to the notch.

3. The auxiliary lock as claimed in claim 1, with the cylinder housing further including a hollow protrusion sandwiched between an outer periphery of the cylinder and an inner periphery delimiting the longitudinal hole of the dustproof support ring.

4. The auxiliary lock as claimed in claim 1, with the trim including a longitudinal hole, a first flange being formed around an outer end of the longitudinal hole, a second flange projecting perpendicularly from a peripheral edge of the first flange, defining a space between an inner wall of the trim, the first flange, and the second flange for receiving an outer end portion of the cylinder housing.

5. The auxiliary lock as claimed in claim 4, with the trim further including a third flange extending radially inward from the second flange of the trim and defining a portion of the longitudinal hole of the trim, the cylinder further including a flange on an outer end thereof, with the flange of the cylinder abutting against the third flange of the trim.

6. The auxiliary lock as claimed in claim 1, with the dustproof support ring further including a second flange on an outer side thereof, with the trim including an inner end fittingly received between the second flange of the dustproof support ring and an outer periphery of the cylinder housing while allowing free rotation of the trim with respect to the cylinder housing and the dustproof support ring.

7. The auxiliary lock as claimed in claim 1, with the trim rotatably enclosing the cylinder hosing.
